(19) United States
(12) Patent Application Publication
(10) Pub. No.: US 2020/0394540 A1
(43) Pub. Date: Dec. 17, 2020

(54) EVALUATION DEVICE

(71) Applicant: NTT DOCOMO, INC., Chiyoda-ku (JP)

(72) Inventors: Keiichi OCHIAI, Chiyoda-ku (JP); Shu TAKAHASHI, Chiyoda-ku (JP); Yusuke FUKAZAWA, Chiyoda-ku (JP)

(73) Assignee: NTT DOCOMO, INC., Chiyoda-ku (JP)

(21) Appl. No.: 16/968,347

(22) PCT Filed: Dec. 5, 2018
(86) PCT No.: PCT/JP2018/044714

§ 371 Date: Aug. 7, 2020

(30) Foreign Application Priority Data
Mar. 29, 2018 (JP) 2018-064566

(51) Int. Cl. G06N 5/04; G06Q 30/02

(52) U.S. Cl. CPC G06N 5/04; G06Q 30/0201

(57) ABSTRACT

A content evaluation device includes a usage trend storage unit that stores, for each user, trend information indicating a usage trend in each time period and for each content type, a score calculation unit that calculates a recommendation score for each content, a classification unit that clusters a group of users having similar trend information on the basis of the trend information of each user, a derivation unit that derives overall trend information from the trend information of affiliated users belonging to the clustered group of users, a score adjustment unit that adjusts the recommendation score of each content in reflection of the overall trend information in a target time period to a recommendation score for each content, and a determination unit that determines content to recommend to the target user in the target time period on the basis of the adjusted recommendation score of each content.

### TECHNICAL FIELD

An aspect of the present invention relates to an evaluation device for evaluating trends in a user's preference for content.

### BACKGROUND ART

In the related art, a technology for determining content to recommend to a user on the basis of a content browsing history of the user is known. A recommendation device described in Patent Literature 1 below estimates a similarity of a browsing history among users, calculates a recommendation level of content on the basis of the estimated similarity and the browsing history, and displays the content on the basis of the calculated recommendation level. Further, a recommendation content extraction device described in Patent Literature 2 below calculates a similarity of usage history information regarding content among users, performs clustering for each user on the basis of the similarity, and determines content of a recommendation target service included in usage history information of another user classified into the same cluster as a recommendation target user as content to recommend to the recommendation target user.

### CITATION LIST

### Patent Literature

[Patent Literature 1] Japanese Unexamined Patent Publication No. 2013-25325

[Patent Literature 2] Japanese Unexamined Patent Publication No. 2011-81728

### SUMMARY OF INVENTION

### Technical Problem

In the technology described in Patent Literature 2, for example, the recommendation content extraction device determines content that is most frequently purchased by other users in the same cluster, content sold most recently to other users in the same cluster, or the like as recommendation content. Therefore, it is often difficult to recommend the content while reflecting trends in the user's preference for content in individual time periods.

Therefore, in order to solve the above-described problem, an aspect of the present invention has been made in view of such a problem, and an object of an aspect of the present invention is to provide an evaluation device capable of appropriately recommending content while reflecting trends in a user's preference for content in individual time periods.

### Solution to Problem

In order to solve the above-described problem, an evaluation device according to an aspect of the present invention includes a preference trend storage unit configured to store trend information for each of a plurality of users, indicating a trend in a preference for content in each of a plurality of time periods and for each type of content; a score calculation unit configured to calculate a recommendation score for each of a plurality of pieces of content with respect to a recommendation target user; a classification unit configured to cluster a group of users having trend information similar to that of the recommendation target user on the basis of the trend information for each of the plurality of users stored in the preference trend storage unit; a derivation unit configured to derive an overall trend of the trend information of affiliated users belonging to the group of users clustered by the classification unit as overall trend information on the basis of the trend information of the affiliated users; a score adjustment unit configured to adjust the recommendation score for each of the plurality of pieces of content in reflection of the overall trend information of the type of content to which the plurality of pieces of content belong in the target time period in the recommendation score for each of the plurality of pieces of content calculated by the score calculation unit; and a determination unit configured to determine content to recommend to the target user with respect to the target time period on the basis of the recommendation score for each of the plurality of pieces of content adjusted by the score adjustment unit.

According to the above aspect, trend information indicating a trend in preference for content in each time period is stored for each user, a group of users having trend information similar to that of the recommendation target user are clustered, overall trend information indicating an overall trend of the group of users is derived from the trend information of the group of users, and a recommendation score for each of a plurality of pieces of content is adjusted in reflection of the overall trend information. Content to recommend to the user for the target time period is determined on the basis of the adjusted recommendation score. Thus, it is possible to reflect trends in the preference in each time period of a user having similar preference trends and appropriately recommend content while reflecting in the recommendation score the trends in each clustered user's preference in each time period.

### Advantageous Effects of Invention

According to an aspect of the present invention, it is possible to appropriately recommend content in reflection of trend in a user's preference for content in individual time periods.

### BRIEF DESCRIPTION OF DRAWINGS

FIG. 1 is a block diagram illustrating a configuration of a content evaluation device 1 according to a preferred embodiment of the present invention.

FIG. 2 is a diagram illustrating an example of a data structure of usage history information stored in a history storage unit 101 in FIG. 1.

FIG. 3 is a diagram illustrating an example of a data structure of a totaling result stored in a usage frequency storage unit 103 by a totaling unit 102 in FIG. 1.

FIG. 4 is a diagram illustrating an example of a data structure of trend information stored in a usage trend storage unit 104 by the totaling unit 102 in FIG. 1.

FIG. 5 is a diagram illustrating an example of a data structure of overall trend information stored in a cluster trend storage unit 108 by the derivation unit 107 in FIG. 1.

FIG. 6 is a flowchart illustrating an operation procedure of an evaluation process of the content evaluation device 1 in FIG. 1.

FIG. 7 is a flowchart illustrating a detailed operation procedure of a score adjustment process in FIG. 6.

FIG. 8 is a diagram illustrating an example of a hardware configuration of a computer 20 constituting the content evaluation device 1 in FIG. 1.

### DESCRIPTION OF EMBODIMENTS

Hereinafter, an embodiment of the present invention will be described with reference to the accompanying drawings. The same portions are denoted by the same reference numerals, and redundant description will be omitted, if possible.

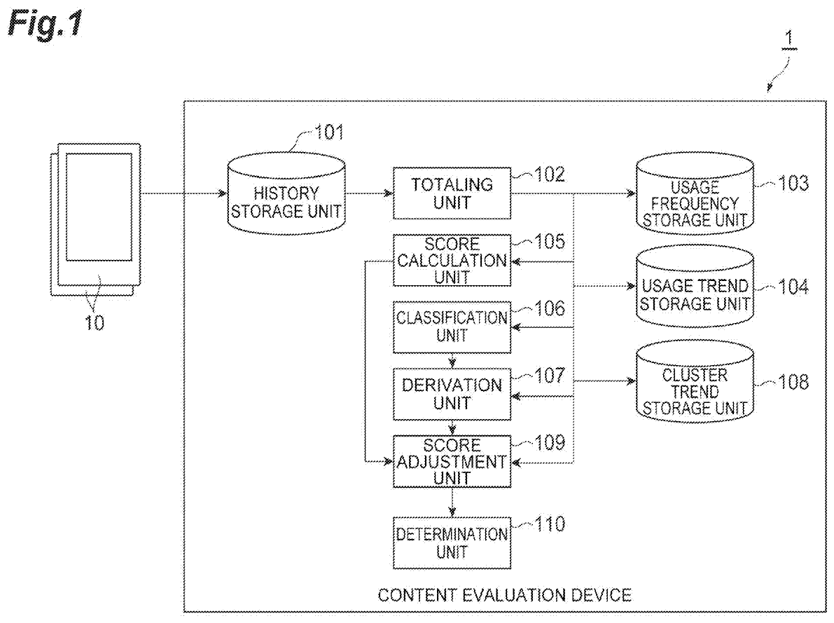

FIG. 1 is a block diagram illustrating a configuration of a content evaluation device 1 according to a preferred embodiment of the present invention. This content evaluation device 1 is a server device that analyzes a usage trend, which is a trend in a preference for content that is distribution data such as music data, video data, or information data provided to mobile communication terminals 10 including smartphones, tablet terminals, feature phones, or the like used by a plurality of users via a communication network, and provides recommendation information on the content on the basis of an analysis result. The plurality of mobile communication terminals 10 can perform communication by communicatively connecting to the content evaluation device 1 via a communication network such as a mobile communication network.

Content that is a target of the recommendation information provided by the content evaluation device 1 is distributed to the mobile communication terminal 10 from the server device on the communication network and then reproduced on the mobile communication terminal 10. Examples of such content include music, movies, dramas, news, and sports, but are not limited to specific types as long as the content can be distributed to the mobile communication terminal 10.

As illustrated in FIG. 1, the content evaluation device 1 includes a history storage unit 101, a totaling unit 102, a usage frequency storage unit 103, a usage trend storage unit (a preference trend storage unit) 104, a score calculation unit 105, a classification unit 106, a derivation unit 107, a cluster trend storage unit 108, a score adjustment unit 109, and a determination unit 110. Hereinafter, respective components of the content evaluation device 1 will be described.

The history storage unit 101 stores usage history information on a usage history of content of users of the plurality of mobile communication terminals 10 in advance. This usage history information is generated on the basis of a reproduction log of the content reproduced in the plurality of mobile communication terminals 10 and stored. For example, the usage history information is stored in the history storage unit 101 by the content evaluation device 1 collecting the reproduction log of the plurality of mobile communication terminals 10 at an arbitrary timing (for example, a periodic timing).

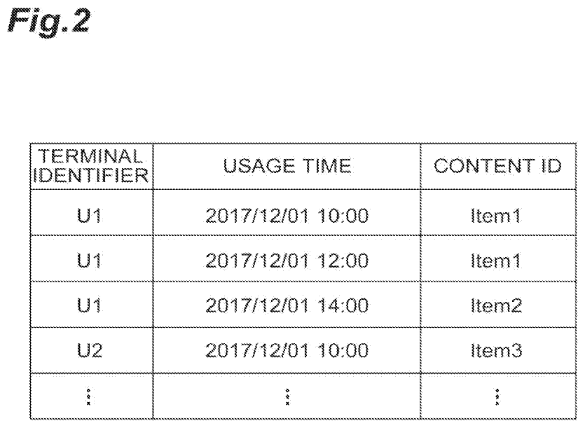

FIG. 2 illustrates an example of a data structure of the usage history information stored in the history storage unit 101. As illustrated in FIG. 2, a plurality of pieces of usage history information on usage (reproduction) of content at a plurality of timings by a plurality of users are accumulated and stored in the history storage unit 101. a terminal identifier (for example, “U1”) that is user specifying information for specifying a user, a content ID (for example, “Item1”) that is content specifying information for specifying the content reproduced by the user, and a reproduction time (for example, “2017/12/01 10:00”) of the content are associated with each of the pieces of usage history information. Although information on a reproduction start time of the content is stored here, other information (for example, information on a reproduction end time of the content or information on a distribution time of the content) may be stored as long as the information is information on a usage time of the content.

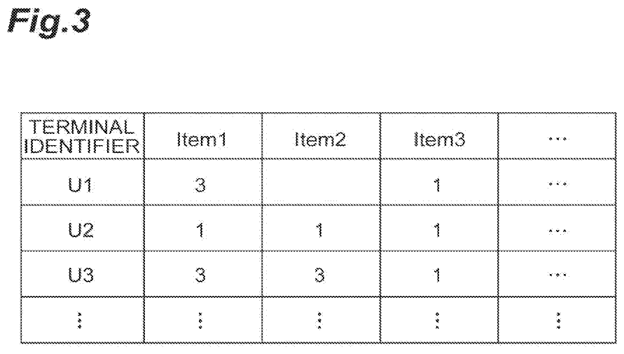

Referring back to FIG. 1, the totaling unit 102 extracts and reads usage history information of each user of which the usage time of the content is within a predetermined period (for example, within the past month or week) from the usage history information stored in the history storage unit 101 on the basis of the terminal identifier, totals a usage frequency of each piece of content for each user, and stores a totaling result in the usage frequency storage unit 103. FIG. 3 illustrates an example of a data structure of a totaling result stored in the usage frequency storage unit 103 by the totaling unit 102. Thus, data of usage frequency of respective pieces of content specified by the content IDs “Item1,” “Item2,” and “Item3” is stored in association with terminal identifiers “U1,” “U2,” and “U3” specifying respective users.

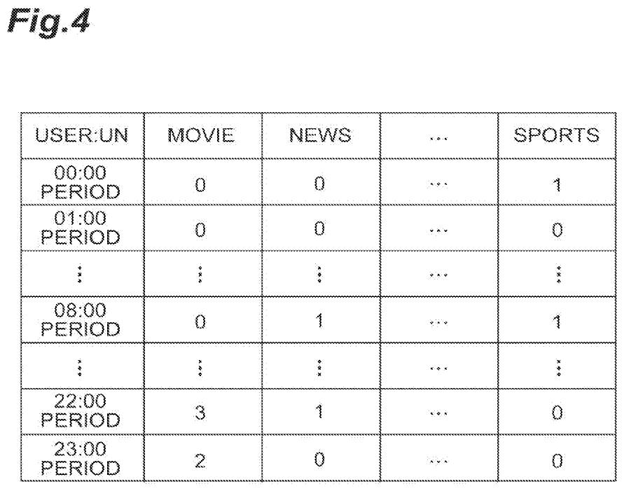

Further, the totaling unit 102 totals trend information indicating a usage trend that is a trend in a preference for the content in each of a plurality of time periods and for each type of content on the basis of the usage history information of each user of which the usage time of the content is within the predetermined period, and stores the trend information for each of a plurality of users in the usage trend storage unit 104. FIG. 4 illustrates an example of a data structure of the trend information stored in the usage trend storage unit 104 by the totaling unit 102. Thus, as trend information corresponding to the user specified by a terminal identifier “UN,” data indicating a distribution of numerical values of the usage frequency of the content in each time period (for example, “00:00 period,” “01:00 period”) for each type of content (for example, “movie” or “news”) is totaled and stored.

Referring back to FIG. 1, the score calculation unit 105 calculates a recommendation score indicating a level of recommendation for each of a plurality of pieces of content with respect to a target user to whom recommendation information is provided. This score calculation unit 105 uses, for example, a collaborative filtering (CF) scheme as a recommendation score calculation scheme. This collaborative filtering is a scheme of calculating a similarity of a usage trend among users on the assumption that a group of users having similar usage (viewing) trends will use content with a similar usage trend in the future, and calculating a level of recommendation (a recommendation score) of a target user using a value obtained by weighting the group usage history by a similarity. Using such a scheme, it is possible to predict a content usage level of the target user with respect to unused content (content for which there is no usage history information).

That is, the score calculation unit 105 reads the usage frequency of each piece of content for each user from the usage frequency storage unit 103. The similarity among the respective users is calculated by a cosine similarity using Equation (1) below:

$$[ Equation 1 ]$$

$${w}_{i , k} = \frac{{Σ}_{{l}_{j} ∈ L} {C}_{i , j} {C}_{k , j}}{\sqrt{{Σ}_{{l}_{j} ∈ L} {C}_{i , j}^{2}} \sqrt{{Σ}_{{l}_{j} ∈ L} {C}_{k , j}^{2}}} \qquad ( 1 )$$

In Equation (1) above, C_{i,j} indicates a usage frequency of content “j” by a user “i,” C_{k,j} indicates a usage frequency of the content “j” by a user “k,” and w_{i,k} indicates a similarity between the user “i” and the user “k.” Thus, the similarity w_{i,k} is calculated by dividing a sum of products of the usage frequency of the user “i” and a usage frequency of the user “k” regarding respective pieces of content by a product of square roots of sums of squares of the usage frequencies of the respective users “i” and “k.”

Further, the score calculation unit 105 calculates a recommendation score C\hat{ }_{i,j} for each piece of content “j” for the target user “i” using the following Equation (2) using the calculated similarity w_{i,k};

$$[ Equation 2 ]$$

$${\hat{C}}_{i , j} = \frac{{Σ}_{{u}_{k}} {w}_{i , k} {C}_{k , j}}{{Σ}_{{u}_{k}} {w}_{i , k}} \qquad ( 2 )$$

Thus, the recommendation score C\hat{ }_{i,j} is calculated by dividing a sum of values obtained by multiplying the usage frequency C_{k,j} of the content “j” by each user “k” by the similarity w_{i,k} between the user “k” and the user “i” by a sum of the similarities w_{i,k}.

The score calculation unit 105 may calculate the recommendation score for each piece of content using a matrix factorization (MF) scheme, as substitute for the collaborative filtering. MF is a technology for predicting a value of a portion in which a value is missing by performing matrix decomposition on only a portion in which there is a value with respect to values of usage frequencies of respective pieces of content for respective users constituting a matrix. Further, the score calculation unit 105 may calculate the recommendation score for each piece of content using a supervised machine learning model called a factorization machine (FM).

The classification unit 106 clusters a group of users having trend information similar to that of the target users, on the basis of the trend information for each of the plurality of users stored in the usage trend storage unit 104. That is, the classification unit 106 reads a distribution (trend information) of usage frequency values for each content type and in each time period for each user from the usage trend storage unit 104, and develops this distribution into a one-dimensional vector. For example, according to the example of FIG. 4, the classification unit 106 develops usage frequency values “0,” “1,” . . . , and “1” for each content type in a time period “00:00 period” and usage frequency values “0,” “0,” . . . , and “0” for each content type in a time period “01:00 period” into the one-dimensional vector “[0, 1, . . . , 1, 0, 0, . . . , 0, . . . ] with respect to a usage frequency value of a user “UN.” Further, the classification unit 106 regards the vector of each user after the development as a feature vector indicating the usage trend of the content in each time period for each user, and clusters a group of users having similar feature vectors using a clustering scheme such as a k-means method with respect to these vectors.

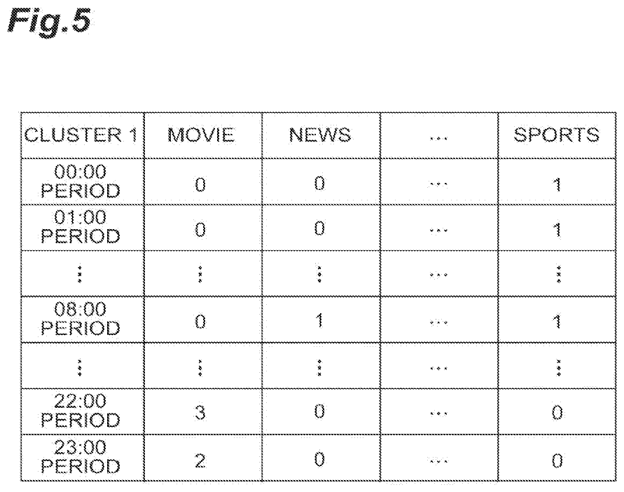

On the basis of a result of clustering in the classification unit 106, the derivation unit 107 derives a trend of the overall trend information of the affiliated users belonging to the cluster as overall trend information using the trend information of the affiliated users belonging to the cluster (a group of users) including the target user. Specifically, the derivation unit 107 reads the trend information regarding all the affiliated users belonging to the cluster of the target user from the usage trend storage unit 104, calculates an average value of the usage frequency values of each content type in each time period among all the affiliated users, and stores the calculated average value in each time period and for each content type in the cluster trend storage unit 108 as the overall trend information. FIG. 5 illustrates an example of a data structure of the overall trend information stored in a cluster trend storage unit 108 by the derivation unit 107. Thus, an average value (for example, “0,” “0,” . . . , and “1”) of usage frequency values for each content type (for example, “movie,” “news,” . . . , “sports”) in each time period (for example, “00:00 period”) is stored as the overall trend information of the cluster “cluster 1” to which the target user belongs.

Referring back to FIG. 1, the score adjustment unit 109 adjusts the recommendation score for each piece of content calculated with respect to the target user by the score calculation unit 105 in reflection of the overall trend information on the cluster to which the target user belongs, which has been derived by the derivation unit 107. Specifically, the score adjustment unit 109 reads, from the cluster trend storage unit 108, the overall trend information of the cluster to which the target user belongs, which corresponds to the time period including a target time in which the recommendation information is generated. The score adjustment unit 109 adjusts the recommendation score by adding a numerical value based on a value of the overall trend information corresponding to the content type to which each piece of content belongs, to the recommendation score of each piece of content calculated by the score calculation unit 105. For example, the score adjustment unit 109 adjusts the recommendation score C\hat{ }₁ calculated by the score calculation unit 105 into a value C\hat{ }₁₀ using the following equation:

C\hat{ }₁₀=C\hat{ }₁+α×AV₁

using an average value AV₁ of the usage frequency values included in the overall trend information, and a predetermined coefficient α.

More specifically, when the score adjustment unit 109 adjusts the recommendation score C\hat{ }₁=“0.8” calculated for content “movie A” by the score calculation unit 105 into a recommendation score C\hat{ }₁₀ at time “22:00” of the recommendation target, the score adjustment unit 109 calculates the recommendation score C\hat{ }₁₀ as

C\hat{ }₁₀=0.8+1.0×3=3.8

by referring to an average value AV₁=“3” corresponding to “22:00 period” and a content type “movie” from the overall trend information as illustrated in FIG. 5. This calculation example is an example when the coefficient α has been set to 1.0. Similarly, the score adjustment unit 109 repeatedly calculates the recommendation score C\hat{ }₁₀ of all content that can be a recommendation target.

The determination unit 110 determines the content to recommend to the target user in a time period including the recommendation target time on the basis of the recommendation score of each piece of content calculated by the score adjustment unit 109. For example, the determination unit 110 may determine content with a relatively high recommendation score as content to recommend or may determine content with a recommendation score higher than a preset threshold value to be the content to recommend. Information on the recommendation content determined as described above (recommendation information) can be referred to by the mobile communication terminal 10 via the communication network. The recommendation information may be actively transmitted from the content evaluation device 1 to the outside such as the mobile communication terminal 10 or the like via the communication network.

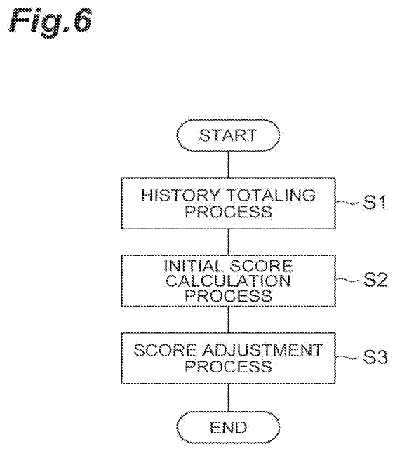

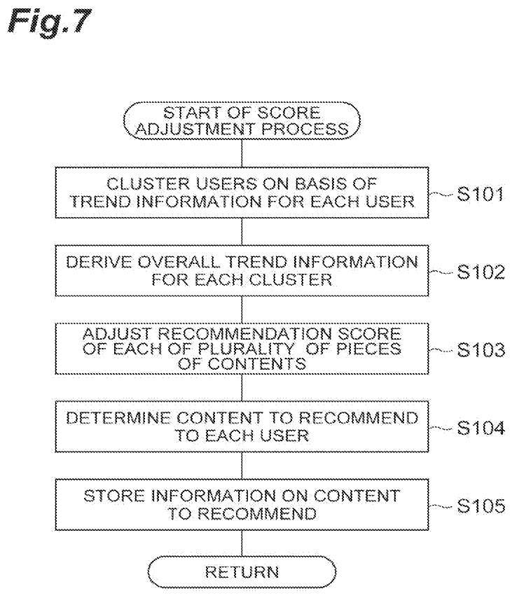

Next, an evaluation process of the content evaluation device 1 having the above-described configuration will be described. FIG. 6 is a flowchart illustrating an operation procedure of the evaluation process of the content evaluation device 1, and FIG. 7 is a flowchart illustrating a detailed operation procedure of a score adjustment process in FIG. 6.

The content evaluation process of the content evaluation device 1 illustrated in FIG. 6 is automatically started at an arbitrary timing (a regular or scheduled timing). When this evaluation process is started, a history totaling process of totaling a usage history of content of each user (step S1), an initial score calculation process that is a process of calculating an initial recommendation score of each piece of content for the target user (step S2), and a score adjustment process of adjusting the initial recommendation score (step S3) are executed in this order.

In the history totaling process (step S1), the totaling unit 102 generates a totaling result of totaling the usage frequency of each piece of content with respect to the usage history information of each user, and stores the totaling result in the usage frequency storage unit 103. In addition, the totaling unit 102 generates the trend information indicating the usage trend of the content in each of a plurality of time periods and each type of content with respect to the usage history information of each user, and stores the trend information in the usage trend storage unit 104.

In the initial score calculation process (step S2), the score calculation unit 105 calculates an initial value of the recommendation score of each piece of content with respect to a plurality of target users on the basis of the usage frequency of each piece of content regarding each user stored in the usage frequency storage unit 103.

The score adjustment process (step S3) is executed according to the procedure illustrated in FIG. 7. First, the classification unit 106 clusters a group of users having trend information similar to that of the plurality of target users on the basis of the trend information for each of the plurality of users stored in the usage trend storage unit 104 (step S101). The derivation unit 107 derives the overall trend information by averaging the trend information of affiliated users belonging to the cluster for each cluster to which the target user belongs (step S102). Then, the score adjustment unit 109 adjusts the initial value of the recommendation score of each piece of content calculated for each target user in reflection of the overall trend information corresponding to the cluster to which the target user belongs, and calculates a final value of the recommendation score of each piece of content (step S103).

Thereafter, the determination unit 110 determines the content to recommend to the target user by referring to the final value of the recommendation score of each piece of content for each target user (step S104). The determination unit 110 stores the recommendation information on the content to recommend, for example, in an internal memory of the content evaluation device 1 (step S105). Thereby, the recommendation information can be referred to by the mobile communication terminal 10.

Next, operations and effects of the content evaluation device 1 of the embodiment will be described. In this content evaluation device 1, trend information indicating a usage trend, which is a trend in the preference for the content in each time period, is stored for each user, a group of users having trend information similar to that of the recommendation target user are clustered, overall trend information indicating an overall trend of the group of users is derived from the trend information of the group of users, and a recommendation score for each of a plurality of pieces of content is adjusted in reflection of the overall trend information. Content to recommend to the user regarding the target time period is determined on the basis of the adjusted recommendation score.

Thus, it is possible to reflect the usage trend of the users having similar usage trends in each time period and appropriately recommend the content while reflecting in the recommendation score the usage trend of each clustered user in each time period. That is, it is possible to recommend content according to the preference of the user in each time period while reflecting the usage trend in each time period in the initial recommendation score derived through collaborative filtering or the like. In particular, since the usage trend of the cluster to which the recommendation target user belongs is reflected, it is possible to appropriately recommend content while reflecting the usage trend of all users even when the usage history of the recommendation target user is sparse.

Further, in the above embodiment, the trend information in each of a plurality of time periods and for each type is developed into a vector, and a group of users having similar vectors is clustered. With such a configuration, it is possible to efficiently cluster the group of users having similar usage (viewing) trends in each time period. As a result, it is possible to improve the efficiency of the process of evaluating recommendation content.

Further, in the above embodiment, an average value of the trend information of the affiliated users belonging to respective clusters is calculated as the overall trend information. With such a configuration, it is possible to calculate the overall trend of the clustered group of users easily and appropriately. As a result, it is possible to more appropriately recommend the content in reflection of the usage trend of the users having similar usage trends in each time period.

Further, in the above embodiment, the recommendation score is adjusted by adding a numerical value based on the overall trend information to the recommendation score. By doing this, it is possible to more easily calculate the recommendation score in which the overall trend of the clustered group of users is reflected. As a result, it is possible to recommend the content through more efficient calculation in reflection of the usage trend of the users having similar usage trends in each time period.

The block diagram used for the description of the above embodiment illustrates blocks in units of functions. Functional blocks (constituent units) thereof are realized by an arbitrary combination of hardware and/or software. Further, a means for realizing each functional block is not particularly limited. That is, each functional block may be realized by one physically and/or logically coupled device or may be realized by a plurality of devices in which two or more physically and/or logically separated devices are connected directly and/or indirectly (for example, by a cable and/or wirelessly).

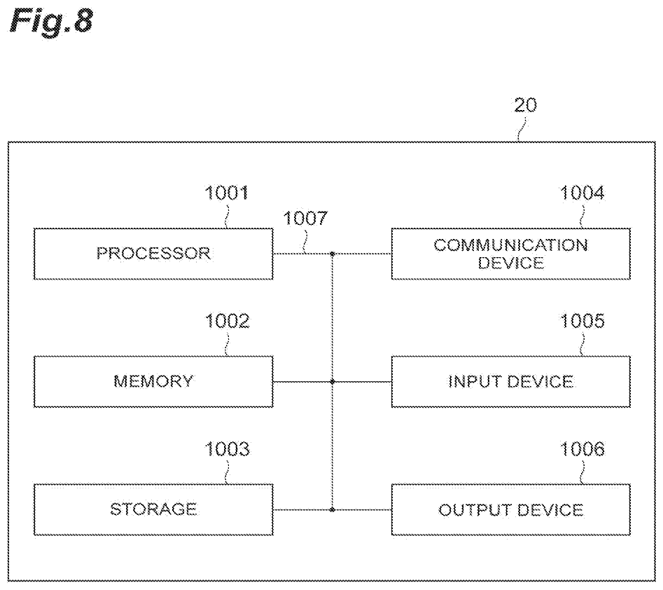

For example, a device constituting the content evaluation device 1 according to an embodiment of the present invention may function as a computer that performs the process of the content evaluation device 1 according to the embodiment. FIG. 8 is a diagram illustrating an example of a hardware configuration of the computer 20 constituting the content evaluation device 1 according to the embodiment. The above-described computer 20 may physically include a processor 1001, a memory 1002, a storage 1003, a communication device 1004, an input device 1005, an output device 1006, a bus 1007, and the like.

In the description in the present specification, the term “device” can refer to a circuit, a device, a unit, or the like. The hardware configuration of the computer 20 may be configured to include one or a plurality of illustrated devices, or may be configured without including some of the devices.

Each function in the computer 20 is realized by loading predetermined software (a program) into hardware such as the processor 1001 or the memory 1002 so that the processor 1001 performs calculation to control communication that is performed by the communication device 1004 or reading and/or writing of data in the memory 1002 and the storage 1003.

The processor 1001, for example, operates an operating system to control the entire computer. The processor 1001 may be configured as a central processing unit (CPU) including an interface with a peripheral device, a control device, a calculation device, a register, and the like. For example, the totaling unit 102, the score calculation unit 105, the classification unit 106, the derivation unit 107, the score adjustment unit 109, the determination unit 110, and the like may be realized by the processor 1001.

Further, the processor 1001 reads a program (program code), a software module, or data from the storage 1003 and/or the communication device 1004 to the memory 1002 and executes various processes according to the program, the software module, or the data. As the program, a program for causing the computer to execute at least part of the operation described in the above embodiment may be used. For example, the totaling unit 102 of the computer 20 may be realized by a control program stored in the memory 1002 and operating on the processor 1001, or other functional blocks may be realized similarly. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage unit), or the like. The memory 1002 can store an executable program (program code), software modules, and the like in order to implement a determination process according to the embodiment of the present invention.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database, a server, or another appropriate medium including the memory 1002 and/or the storage 1003. For example, the history storage unit 101, the usage frequency storage unit 103, the usage trend storage unit 104, the cluster trend storage unit 108, and the like may be realized by the storage 1003.

The communication device 1004 is hardware (a transmission and reception device) for performing communication between computers via a wired and/or wireless network and is also referred to as a network device, a network controller, a network card, or a communication module, for example.

The input device 1005 is an input device that receives an input from the outside. The output device 1006 is an output device that performs output to the outside. The input device 1005 and the output device 1006 may be realized by a touch panel display in which both of the input device 1005 and the output device 1006 are integrated.

Further, the respective devices such as the processor 1001 and the memory 1002 is connected by the bus 1007 for information communication. The bus 1007 may be configured as a single bus or may be configured as different buses between the devices.

Further, the computer 20 may include hardware such as a microprocessor, a digital signal processor (DSP), an application specific integrated circuit (ASIC), a programmable logic device (PLD), or a field programmable gate array (FPGA), and a part or all of each functional block may be realized by the hardware. For example, the processor 1001 may be implemented by at least one piece of the hardware.

Although the present invention has been described in detail above, it is apparent to those skilled in the art that the present embodiment is not limited to the embodiment described in the present specification. The present embodiment can be implemented as a modified and changed aspect without departing from the spirit and scope of the present invention defined by the description of the claims. Accordingly, the description of the present specification is intended for illustration and does not have any restrictive meaning with respect to the present embodiment.

For example, although the derivation unit 107 of the above embodiment derives the overall trend information as an average value of the usage frequency values of the affiliated users, the derivation unit 107 may derive other statistical values such as a median value or an addition value of the usage frequency values of the affiliated users as the overall trend information. Thus, it is possible to calculate the overall trend of the clustered group of users easily and appropriately. As a result, it is possible to more appropriately recommend the content while reflecting the usage trend of the users having similar usage trends in each time period.

Further, although the score adjustment unit 109 of the above embodiment adjusts the initial value of the recommendation score for each piece of content by adding the numerical value based on the value of the overall trend information to the initial value, the score adjustment unit 109 may adjust the initial value of the recommendation score by multiplying the initial value by a numerical value based on the value of the overall trend information. Thus, it is possible to more easily calculate the recommendation score in which the overall trend of the clustered group of users has been reflected. As a result, it is possible to recommend the content through more efficient calculation while reflecting the usage trend of the users having similar usage trends in each time period.

Further, although the content evaluation device 1 of the above-described embodiment analyzes the usage trend that is a trend in the preference for the content and provides the recommendation information regarding the content on the basis of an analysis result, the content evaluation device 1 may collect and analyze rating values (for example, numerical values for evaluation in five levels), which are results of each user rating the respective contents.

In such a case, the rating values for the contents are stored in the usage frequency storage unit 103 instead of the numeric value of the usage frequency of the contents, which is the usage trend. The score calculation unit 105 calculates the recommendation score for each piece of content using the above-described scheme using the rating values of the respective contents regarding the respective users. Further, the classification unit 106 clusters the group of users on the basis of the trend information including the rating values, the derivation unit 107 derives the overall trend information using the trend information including the rating values, and the score adjustment unit 109 adjusts the recommendation score for each piece of content in reflection of the overall trend information derived from the trend information including the rating values.

Further, each aspect/embodiment described in the present specification may be applied to long term evolution (LTE), LTE advanced (LTE-A), SUPER 3G, IMT-Advanced, 4G, 5G, future radio access (FRA), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, ultra wide band (UWB), Bluetooth (registered trademark), a system using another appropriate system, and/or a next generation system extended on the basis of these systems.

A process procedure, a sequence, a flowchart, and the like in each aspect/embodiment described in the present specification may be in a different order unless inconsistency arises. For example, for the method described in the present specification, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present specification may be used alone, may be used in combination, or may be used by being switched according to the execution. Further, a notification of predetermined information (for example, a notification of “being X”) is not limited to be made explicitly, and may be made implicitly (for example, by a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, and the like may be transmitted and received via a transmission medium. For example, when software is transmitted from a website, a server, or another remote source using wired technology such as a coaxial cable, an optical fiber cable, a twisted pair and a digital subscriber line (DSL) and/or wireless technology such as infrared rays, radio, and microwaves, those wired technology and/or wireless technology are included in the definition of the transmission medium.

The information, signals, and the like described in the present specification may be represented by any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

The terms described in the present specification and/or terms necessary for understanding of the present specification may be replaced by terms having the same or similar meanings.

The names used for the above-described parameters are not definitive in any way.

The term “determining” used in the present specification may include a variety of operations. The “determining” can include, for example, regarding calculating, computing, processing, deriving, investigating, looking up (for example, looking up in a table, a database, or another data structure), or ascertaining as “determining” Further, “determining” can include, for example, regarding receiving (for example, receiving information), transmitting (for example, transmitting information), inputting, outputting, or accessing (for example, accessing data in a memory) as “determining” Further, “determining” can include regarding resolving, selecting, choosing, establishing, comparing or the like as “determining” That is, “determining” can include regarding a certain operation as “determining.”

The description “on the basis of” used in the present specification does not mean “on the basis of only” unless otherwise noted. In other words, the description “on the basis of” means both of “on the basis of only” and “on the basis of at least.”

As long as “including”, “comprising” and transformation of them are used in the present specification or claims, those terms are intended to be comprehensive like the term “comprise.” Further, the term “or” used in the present specification or claims is intended not to be exclusive OR.

In the present specification, it is assumed that a plurality of devices are also included in cases other than a case in which there is obviously only one device in the context or technically.

Throughout the present disclosure, it is assumed that a plurality of things are included unless a single thing is clearly indicated by the context.

### INDUSTRIAL APPLICABILITY

In an embodiment of the present invention, the evaluation device that evaluates the trends in the preference for the content in a user is adopted as a usage purpose, and it is possible to appropriately recommend content while reflecting the trends of the user in the preference for the content in each time period.

### REFERENCE SIGNS LIST

1: Content evaluation device
10: Mobile communication terminal
104: Usage trend storage unit
105: Score calculation unit
106: Classification unit
107: Derivation unit
109: Score adjustment unit
110: Determination unit

1. An evaluation device comprising:
a preference trend storage unit configured to store trend information for each of a plurality of users, indicating a trend in a preference for content in each of a plurality of time periods and for each type of content;
a score calculation unit configured to calculate a recommendation score for each of a plurality of pieces of content with respect to a recommendation target user;
a classification unit configured to cluster a group of users having trend information similar to that of the recommendation target user on the basis of the trend information for each of the plurality of users stored in the preference trend storage unit;
a derivation unit configured to derive an overall trend of the trend information of affiliated users belonging to the group of users clustered by the classification unit as overall trend information on the basis of the trend information of the affiliated users;
a score adjustment unit configured to adjust the recommendation score for each of the plurality of pieces of content in reflection of the overall trend information of the type of content to which the plurality of pieces of content belong in the target time period in the recommendation score for each of the plurality of pieces of content calculated by the score calculation unit; and
a determination unit configured to determine content to recommend to the target user with respect to the target time period on the basis of the recommendation score for each of the plurality of pieces of content adjusted by the score adjustment unit.

2. The evaluation device according to claim 1, wherein the preference trend storage unit stores trend information indicating a usage trend of the content as the trend information indicating the trend in the preference.

3. The evaluation device according to claim 1,
wherein the preference trend storage unit stores a numerical value indicating the trends in the preference for the content as the trend information, and
the classification unit develops the trend information in each of the plurality of time periods and for each type into a vector, and clusters a group of users having similar vectors.

4. The evaluation device according to claim 1,
wherein the preference trend storage unit stores a numerical value indicating the trends in the preference for the content as the trend information, and
the derivation unit calculates an average value, a median value, or an addition value with respect to the trend information of the affiliated users belonging to the group of users to derive the overall trend information.

5. The evaluation device according to claim 1, wherein the score adjustment unit adjusts the recommendation score by adding a numerical value based on the overall trend information to the recommendation score or multiplying the recommendation score by the numerical value based on the overall trend information.
